(19) United States
(12) Patent Application Publication
(10) Pub. No.: US 2011/0148398 A1
(43) Pub. Date: Jun. 23, 2011

(54) Gear position detection device

(75) Inventors: Yuchen Yang, Shanghai (CN); Xiaoguang Sun, Shanghai (CN)

(73) Assignee: Tyco Electronics (Shanghai) Co. Ltd., Shanghai (CN)

(21) Appl. No.: 12/928,722

(22) Filed: Dec. 16, 2010

(30) Foreign Application Priority Data
Dec. 22, 2009 (CN) 200910262280.2

(51) Int. Cl. G01B 7/14

(52) U.S. Cl. 324/207.11

(57) ABSTRACT

The present invention discloses a gear position detection device, comprising: a gear lever capable of being shifted into different gear positions; a shaft connected to and driven by the gear lever; a first detector and a second detector symmetrically arranged at both sides of the shaft, the first detector for outputting a first output signal value G1 corresponding to a distance from it to the shaft, and the second detector for outputting a second output signal value G2 corresponding to a distance from it to the shaft; and a means for determining the gear position of the gear lever based on a difference value of the first output signal value G1 and the second output signal value G2. In the present invention, the zero shift error can be effectively eliminated from the difference value, and the present invention can precisely detect the gear position.

### CROSS-REFERENCE TO RELATED APPLICATION

This application claims the benefit of Chinese Patent Application No. 200910262280.2 filed on Dec. 22, 2009 in the State Intellectual Property Office of China, the whole disclosure of which is incorporated herein by reference.

### BACKGROUND OF THE INVENTION

1. Field of the Invention

The present invention relates to a gear position detection device, more particularly, relates to a gear position detection device used in a vehicle, such as a car, a bus or a truck.

2. Description of the Related Art

A conventional gear position detection device applied in a vehicle generally comprises only a single non-contact displacement sensor to detect gear positions, and it determines which of the gear positions the vehicle is shifted into based on a displacement signal from the single non-contact displacement sensor. The most common non-contact displacement sensor includes a linear displacement Hall sensor and a permanent magnetic linear non-contact displacement sensor. Compared with the permanent magnetic linear non-contact displacement sensor, the linear displacement Hall sensor is inexpensive, but has poor detection accuracy.

However, in the conventional gear position detection device adopting a single non-contact displacement sensor, if the manufacturing accuracy of it is not precise enough or it has been used for a long time, a so called “zero shift” phenomenon may be occurred, which may cause the determination of the gear position inaccurate or even incorrect, especially for determination of a zero gear position, and this problem is a great hidden danger for driving.

### SUMMARY OF THE INVENTION

The present invention has been made to overcome or alleviate at least one aspect of the above mentioned disadvantages.

Accordingly, it is an object of the present invention to provide a gear position detection device that can precisely detect which of gear positions a gear lever is shifted into.

According to an aspect of the present invention, there is provided a gear position detection device, comprising: a gear lever capable of being shifted into different gear positions; a shaft connected to and driven by the gear lever; a first detector and a second detector symmetrically arranged at both sides of the shaft, the first detector for outputting a first output signal value G1 corresponding to a distance from it to the shaft, and the second detector for outputting a second output signal value G2 corresponding to a distance from it to the shaft; and a means for determining the gear position of the gear lever based on a difference value of the first output signal value G1 and the second output signal value G2.

In an exemplary embodiment according to the present invention, the shaft having a first detection surface, a second detection surface, a third detection surface and a fourth detection surface; when the gear lever is shifted into a first gear position, the first detector faces the first detection surface and is away from the first detection surface at a first distance D1, and the second detector faces the fourth detection surface and is away from the fourth detection surface at a fourth distance D4; when the gear lever is shifted into a second gear position, the first detector faces the fourth detection surface and is away from the fourth detection surface at the fourth distance D4; and the second detector faces the first detection surface and is away from the first detection surface at the first distance D1; when the gear lever is shifted into a zero gear position between the first and the second gear positions, the first and the second detectors both face the fourth detection surface and are away from the fourth detection surface at the fourth distance D4; when the gear lever is shifted into a third gear position, the first detector faces the second detection surface and is away from the second detection surface at a second distance D2, and the second detector faces the fourth detection surface and is away from the fourth detection surface at a fourth distance D4; when the gear lever is shifted into a fourth gear position, the first detector faces the fourth detection surface and is away from the fourth detection surface at the fourth distance D4; and the second detector faces the second detection surface and is away from the second detection surface at the second distance D2; when the gear lever is shifted into a zero gear position between the third and the fourth gear positions, the first and the second detectors both face the fourth detection surface and are away from the fourth detection surface at the fourth distance D4; when the gear lever is shifted into a fifth gear position, the first detector faces the third detection surface and is away from the third detection surface at a third distance D3, and the second detector faces the fourth detection surface and is away from the fourth detection surface at a fourth distance D4; when the gear lever is shifted into a sixth gear position, the first detector faces the fourth detection surface and is away from the fourth detection surface at the fourth distance D4; and the second detector faces the third detection surface and is away from the third detection surface at the third distance D3; when the gear lever is shifted into a zero gear position between the fifth and the sixth gear positions, the first and the second detectors both face the fourth detection surface and are away from the fourth detection surface at the fourth distance D4; and wherein a difference value of the first distance D1 and the fourth distance D4, a difference value of the second distance D2 and the fourth distance D4, and a difference value of the third distance D3 and the fourth distance D4 are neither equal to each other nor equal to zero, that is, the distances D1, D2, D3 and D4 satisfy a following relational expression:

D1−D4≠D2−D4≠D3−D4≠0 (1).

In another exemplary embodiment according to the present invention, the distances D1, D2, D3 and D4 further satisfy a following relational expression:

D1<D2<D3<D4 (2).

In another exemplary embodiment according to the present invention, the first, second, third and the fourth detection surfaces are arc surfaces with radiuses R1, R2, R3 and R4, respectively.

In another exemplary embodiment according to the present invention, the radiuses R1, R2, R3 and R4 satisfy a following relational expression:

R1>R2>R3>R4 (3).

In another exemplary embodiment according to the present invention, the shaft (100) is symmetrical about its axis.

In another exemplary embodiment according to the present invention, the first detector and the second detector both are linear displacement Hall sensors.

In another exemplary embodiment according to the present invention, the determining means has a subtracter; input ends of the subtracter are connected to output ends of the first and second detectors; and an output end of the subtracter outputs the difference value of the first output signal value G1 from the first detector and the second output signal value G2 from the second detector.

In another exemplary embodiment according to the present invention, the first output signal value G1 and the second output signal value G2 each is in an inverse proportion to the distance from it to the shaft; and when the distance from the first detector to the shaft is equal to the distance from the second detector to the shaft, the first output signal value G1 is equal to the second output signal value G2.

In another exemplary embodiment according to the present invention, when the gear lever is shifted into a first gear position, the first output signal value G1 of the first detector is equal to 3, the second output signal value G2 of the second detector is equal to zero, and the difference value of the first output signal value G1 and the second output signal value G2 is equal to 3; when the gear lever is shifted into a second gear position, the first output signal value G1 of the first detector is equal to zero, the second output signal value G2 of the second detector is equal to 3, and the difference value of the first output signal value G1 and the second output signal value G2 is equal to −3; when the gear lever is shifted into a third gear position, the first output signal value G1 of the first detector is equal to 2, the second output signal value G2 of the second detector is equal to zero, and the difference value of the first output signal value G1 and the second output signal value G2 is equal to 2; when the gear lever is shifted into a fourth gear position, the first output signal value G1 of the first detector is equal to zero, the second output signal value G2 of the second detector is equal to 2, and the difference value of the first output signal value G1 and the second output signal value G2 is equal to −2; when the gear lever is shifted into a fifth gear position, the first output signal value G1 of the first detector is equal to 1, the second output signal value G2 of the second detector is equal to zero, and the difference value of the first output signal value G1 and the second output signal value G2 is equal to 1; when the gear lever is shifted into a sixth gear position, the first output signal value G1 of the first detector is equal to zero, the second output signal value G2 of the second detector is equal to 1, and the difference value of the first output signal value G1 and the second output signal value G2 is equal to −1; when the gear lever is shifted into a zero gear position between the first and the second gear positions or between the third and the fourth gear positions or between the fifth and the sixth gear positions, the first output signal value G1 of the first detector is equal to zero, the second output signal value G2 of the second detector is equal to zero, and the difference value of the first output signal value G1 and the second output signal value G2 is equal to zero.

In the present invention, a first detector and a second detector are arranged at both sides of the shaft, and it determines the gear position of the gear lever based on a difference value of the first output signal of the first detector and the second output signal of the second detector. If the pair of detectors of the present invention each occurs a zero shift error ε after being used for a long time or being subjected to an environmental temperature variation and/or a magnetic field interference, then the difference value of the first output signal and the second output signal=(G1+ε)−(G2+ε)=G1−G2. Obviously, the zero shift error ε can be effectively eliminated from the difference value, and the present invention can precisely detect the gear position.

### BRIEF DESCRIPTION OF THE DRAWINGS

These and/or other aspects and advantages of the invention will become apparent and more readily appreciated from the following description of the embodiments, taken in conjunction with the accompanying drawings, in which:

FIG. 1 is a schematic perspective view of a gear position detection device according to an embodiment of the present invention;

FIG. 2 is a left side view of FIG. 1;

FIG. 3a is a schematic perspective view of a gear position detection device according to an embodiment of the present invention, showing the gear position detection device in a first gear position;

FIG. 3b is a cross section view of FIG. 3a;

FIG. 4a is a schematic perspective view of a gear position detection device according to an embodiment of the present invention, showing the gear position detection device in a second gear position;

FIG. 4b is a cross section view of FIG. 4a;

FIG. 5a is a schematic perspective view of a gear position detection device according to an embodiment of the present invention, showing the gear position detection device in a zero gear position between the first and second gear positions;

FIG. 5b is a cross section view of FIG. 5a;

FIG. 6a is a schematic perspective view of a gear position detection device according to an embodiment of the present invention, showing the gear position detection device in a third gear position;

FIG. 6b is a cross section view of FIG. 6a;

FIG. 7a is a schematic perspective view of a gear position detection device according to an embodiment of the present invention, showing the gear position detection device in a fourth gear position;

FIG. 7b is a cross section view of FIG. 7a;

FIG. 8a is a schematic perspective view of a gear position detection device according to an embodiment of the present invention, showing the gear position detection device in a zero gear position between the third and fourth gear positions;

FIG. 8b is a cross section view of FIG. 8a;

FIG. 9a is a schematic perspective view of a gear position detection device according to an embodiment of the present invention, showing the gear position detection device in a fifth gear position;

FIG. 9b is a cross section view of FIG. 9a;

FIG. 10a is a schematic perspective view of a gear position detection device according to an embodiment of the present invention, showing the gear position detection device in a sixth gear position;

FIG. 10b is a cross section view of FIG. 10a;

FIG. 11a is a schematic perspective view of a gear position detection device according to an embodiment of the present invention, showing the gear position detection device in a zero gear position between the fifth and sixth gear positions; and

FIG. 11b is a cross section view of FIG. 11a.

### DETAILED DESCRIPTION OF PREFERRED EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

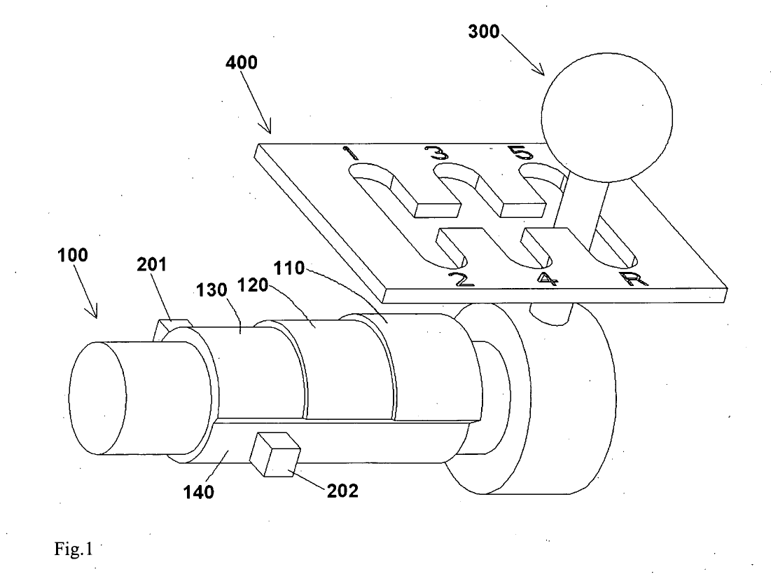

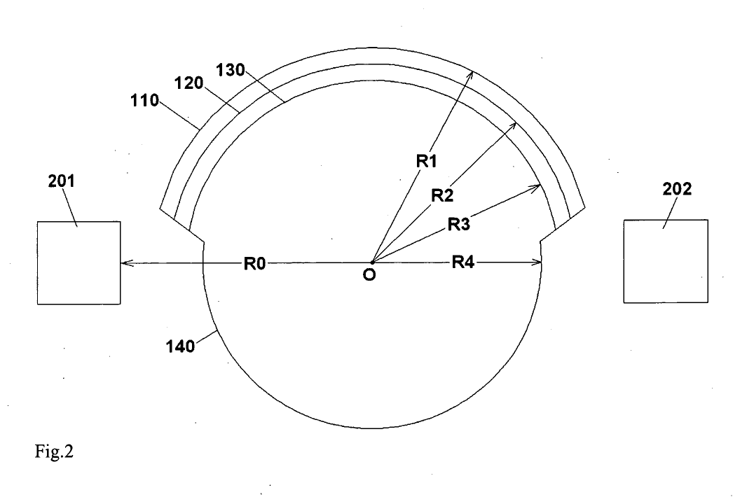

FIG. 1 is a schematic perspective view of a gear position detection device according to an embodiment of the present invention; and FIG. 2 is a left side view of FIG. 1.

As shown in FIG. 1, in an exemplary embodiment, a plate 400 is formed with a slide groove for limiting a plurality of gear positions of a vehicle. A gear lever 300 passes through the slide groove of the plate 400 and can be shifted into any one of the plurality of gear positions. A lower end of the gear lever 300 is connected to a base of a shaft 100. Although the gear lever 300 is directly connected to the shaft 100 as shown in FIG. 1, the gear lever 300 also may be indirectly connected to the shaft 100 by some connection elements, such as screws, pins or the other like.

Referring to FIG. 1, a first detector 201 and a second detector 202 are symmetrically arranged at both sides of the shaft 100. Please be noted that the first detector 201 and the second detector 202 both are fixed and can not be moved in the present invention, and only the shaft 100 is moved along with the gear lever 300.

In this exemplary embodiment of the present invention, the first detector 201 is used to output a first output signal value G1 corresponding to a distance from it to the shaft 100, and the second detector 202 is used to output a second output signal value G2 corresponding to a distance from it to the shaft 100. In the present invention, the first output signal value G1 or the second output signal value G2 may be in a voltage, a current, a distance calculated from the voltage or the current, or the like.

Although it is not shown, the gear position detection device according to the present invention further comprises a means for determining the gear position of the gear lever 300 based on a difference value between the first output signal value G1 and the second output signal value G2.

According to an exemplary embodiment of the present invention, please refer to FIG. 1 and FIG. 2, the shaft 100 has a first detection surface 110, a second detection surface 120, a third detection surface 130 and a fourth detection surface 140. But the present invention is not limited to this, the shaft 100 may have only the fourth detection surface and any one of the first, second and third detection surfaces 110, 120 and 130, or may have only the fourth detection surface and any two of the first, second and third detection surfaces 110, 120 and 130, or may have five or more detection surfaces if necessary.

In the present invention, when the shaft 100 comprises two detection surfaces, it can detect a zero gear position and two non-zero gear positions; when the shaft 100 comprises three detection surfaces, it can detect a zero gear position and four non-zero gear positions; when the shaft 100 comprises four detection surfaces, it can detect a zero gear position and six non-zero gear positions. Therefore, in the exemplary embodiment shown in FIG. 1, it can detect a zero gear position and six non-zero gear positions 1, 2, 3, 4, 5 and R.

In an exemplary embodiment of the present invention, the first, second, third and the fourth detection surfaces 110, 120, 130, 140 are arc surfaces with radiuses R1, R2, R3 and R4, respectively. But the present invention is not limited to this, the first, second, third and the fourth detection surfaces 110, 120, 130, 140 may be flat surfaces.

Referring to FIG. 1, the first, second and the third detection surfaces 110, 120 and 130 together are formed into a three-step type of arc surface on one half portion of the shaft 100, and the fourth detection surface 140 is formed into an uniform arc surface on the other one half portion of the shaft 100.

As shown in FIG. 2, the radiuses of the first, second, third and the fourth detection surfaces 110, 120, 130 and 140 relative to a center of the shaft 100 are denoted as R1, R2, R3 and R4 denote, and a distance from one detector 201 or 202 to the center of the shaft is denoted as R0.

In an exemplary embodiment of the present invention, as shown in FIG. 2, the parameters R0, R1, R2, R3 and R4 satisfy a following relational expression:

R0>R1>R2>R3>R4 (1).

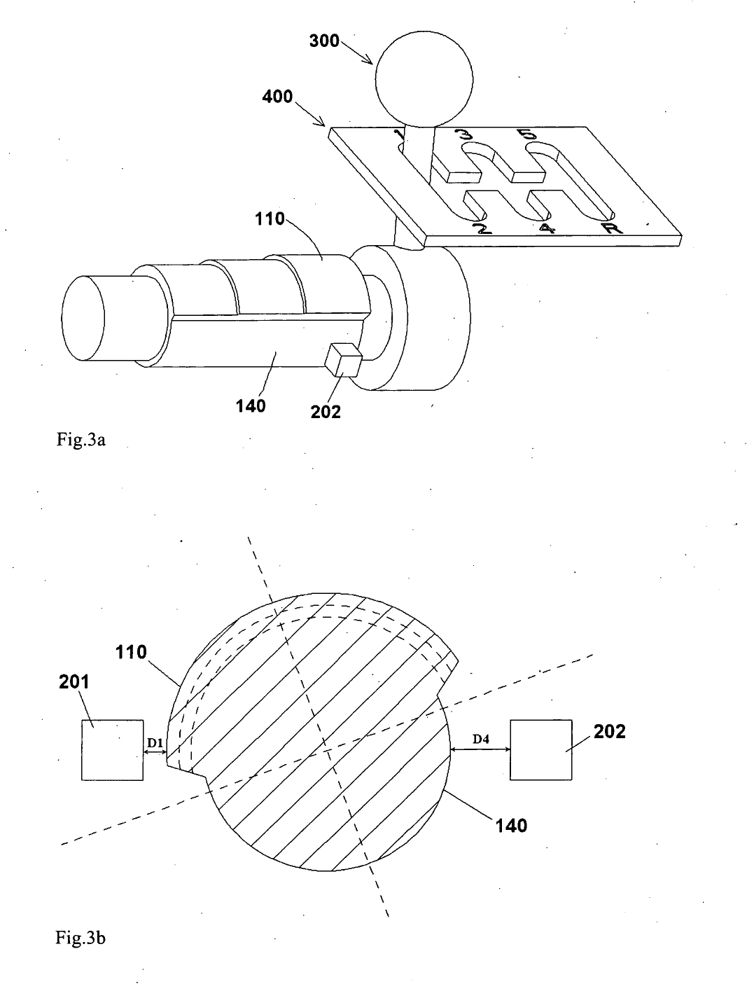

FIG. 3a is a schematic perspective view of a gear position detection device according to an embodiment of the present invention, showing the gear position detection device in a first gear position 1; and FIG. 3b is a cross section view of FIG. 3a.

As shown in FIG. 3a and FIG. 3b, when the gear lever 300 is shifted into a first gear position 1, the first detector 201 faces the first detection surface 110 and is away from the first detection surface 110 at a first distance D1, and the second detector 202 faces the fourth detection surface 140 and is away from the fourth detection surface 140 at a fourth distance D4. Thereby, the first detector 201 outputs a first output signal value G1 corresponding to the first distance D1, and the second detector 202 outputs a second output signal value G2 corresponding to the fourth distance D4. Accordingly, at this time, it may determine that the gear lever 300 is shifted into the first gear position 1 based on the difference value (G1−G2) of the first output signal value G1 of the first detector 201 and the second output signal value G2 of the second detector 202.

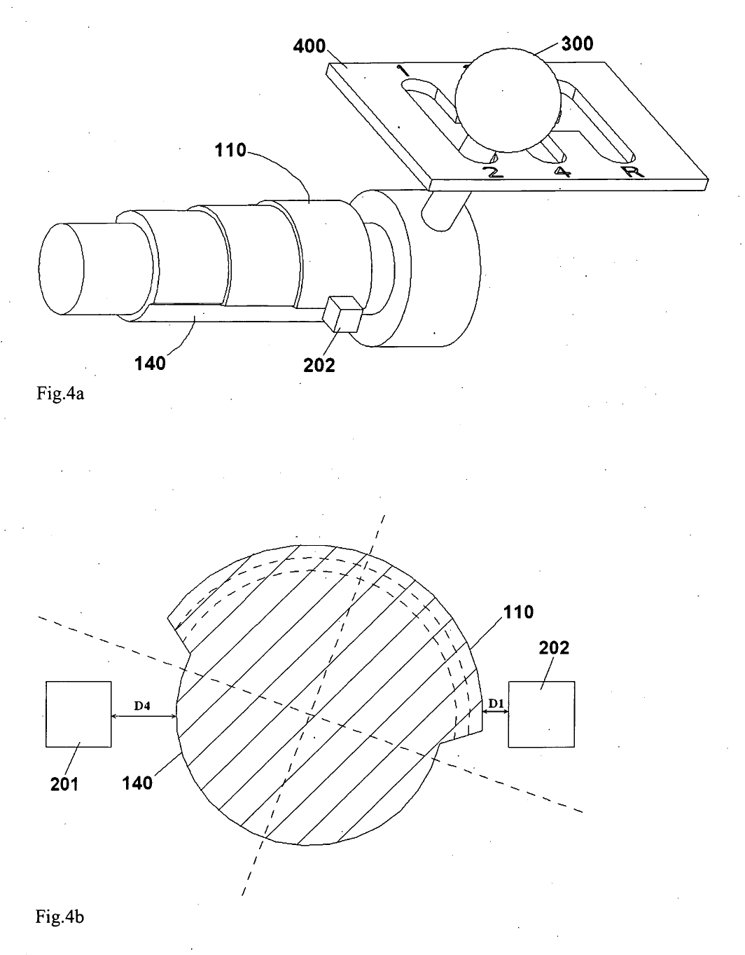

FIG. 4a is a schematic perspective view of a gear position detection device according to an embodiment of the present invention, showing the gear position detection device in a second gear position 2; and FIG. 4b is a cross section view of FIG. 4a.

As shown in FIG. 4a and FIG. 4b, when the gear lever 300 is shifted into a second gear position 2, the first detector 201 faces the fourth detection surface 140 and is away from the fourth detection surface 140 at the fourth distance D4; and the second detector 202 faces the first detection surface 110 and is away from the first detection surface 110 at the first distance D1. Thereby, the first detector 201 outputs a first output signal value G1 corresponding to the fourth distance D4, and the second detector 202 outputs a second output signal value G2 corresponding to the first distance D1. Accordingly, at this time, it may determine that the gear lever 300 is shifted into the second gear position 2 based on the difference value (G1−G2) of the first output signal value G1 of the first detector 201 and the second output signal value G2 of the second detector 202.

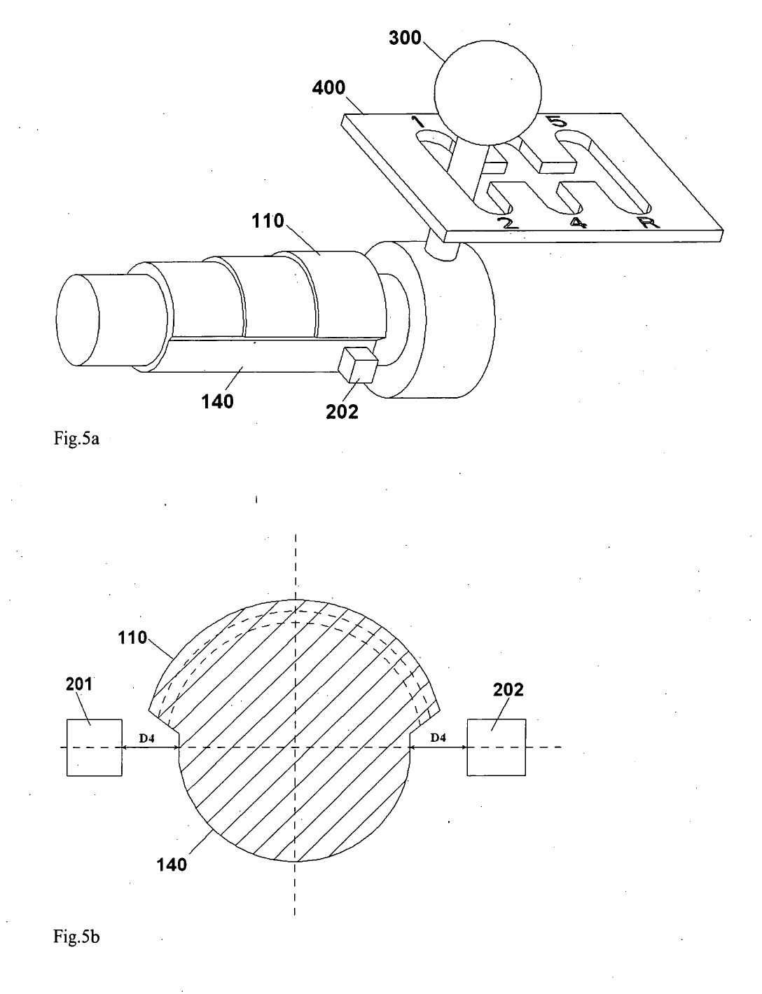

FIG. 5a is a schematic perspective view of a gear position detection device according to an embodiment of the present invention, showing the gear position detection device in a zero gear position between the first and second gear positions 1, 2; and FIG. 5b is a cross section view of FIG. 5a.

As shown in FIG. 5a and FIG. 5b, when the gear lever 300 is shifted into a zero gear position between the first and the second gear positions 1, 2, the first and the second detectors 201, 202 both face the fourth detection surface 140 and are away from the fourth detection surface 140 at the fourth distance D4. Thereby, the first detector 201 outputs a first output signal value G1 corresponding to the fourth distance D4, and the second detector 202 outputs a second output signal value G2 also corresponding to the fourth distance D4. Accordingly, at this time, it may determine that the gear lever 300 is shifted into the zero gear position based on the difference value (G1-G2) of the first output signal value G1 of the first detector 201 and the second output signal value G2 of the second detector 202.

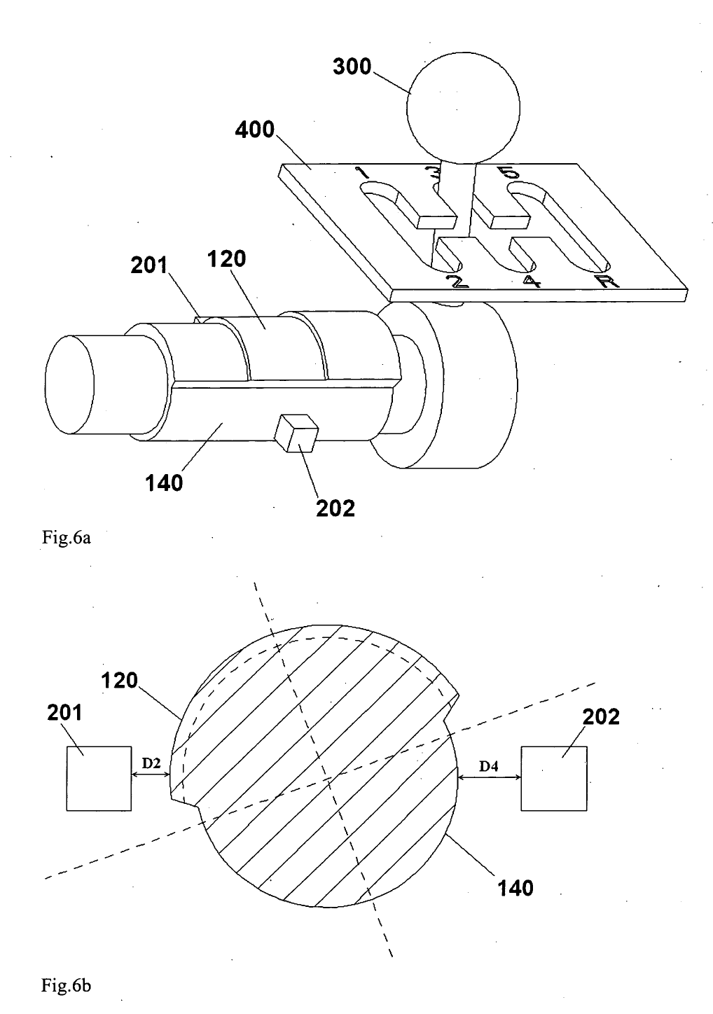

FIG. 6a is a schematic perspective view of a gear position detection device according to an embodiment of the present invention, showing the gear position detection device in a third gear position 3; and FIG. 6b is a cross section view of FIG. 6a.

As shown in FIG. 6a and FIG. 6b, when the gear lever 300 is shifted into a third gear position 3, the first detector 201 faces the second detection surface 120 and is away from the second detection surface 120 at a second distance D2, and the second detector 202 faces the fourth detection surface 140 and is away from the fourth detection surface 140 at a fourth distance D4. Thereby, the first detector 201 outputs a first output signal value G1 corresponding to the first distance D2, and the second detector 202 outputs a second output signal value G2 corresponding to the fourth distance D4. Accordingly, at this time, it may determine that the gear lever 300 is shifted into the third gear position 3 based on the difference value (G1−G2) of the first output signal value G1 of the first detector 201 and the second output signal value G2 of the second detector 202.

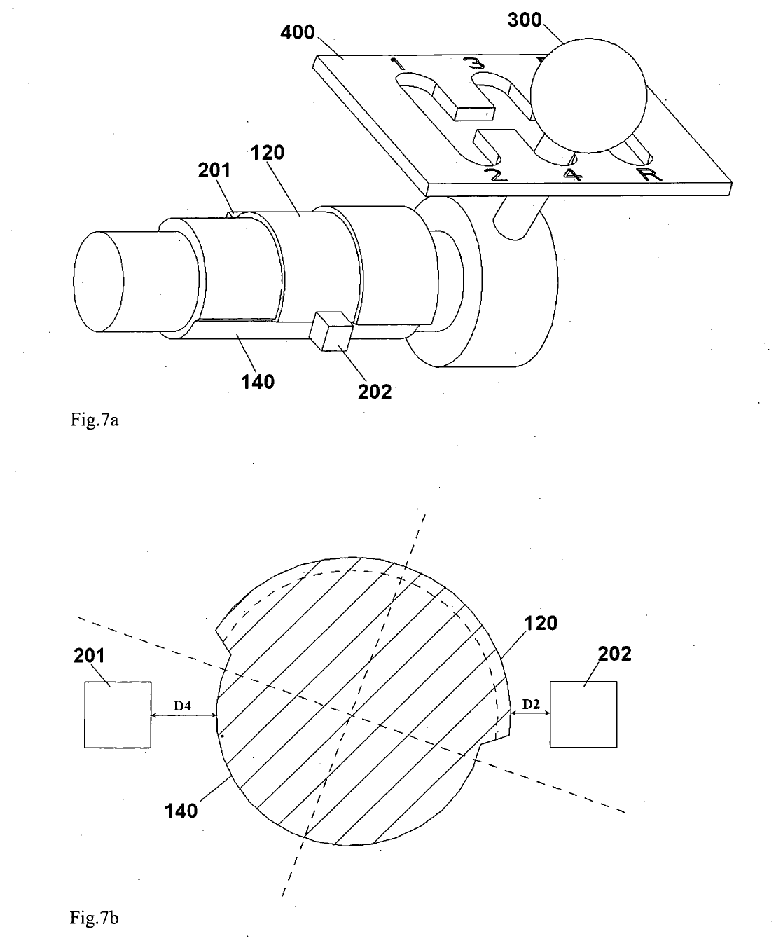

FIG. 7a is a schematic perspective view of a gear position detection device according to an embodiment of the present invention, showing the gear position detection device in a fourth gear position 4; and FIG. 7b is a cross section view of FIG. 7a.

As shown in FIG. 7a and FIG. 7b, when the gear lever 300 is shifted into a fourth gear position 2, the first detector 201 faces the fourth detection surface 140 and is away from the fourth detection surface 140 at the fourth distance D4; and the second detector 202 faces the second detection surface 120 and is away from the second detection surface 120 at the second distance D2. Thereby, the first detector 201 outputs a first output signal value G1 corresponding to the fourth distance D4, and the second detector 202 outputs a second output signal value G2 corresponding to the first distance D2. Accordingly, at this time, it may determine that the gear lever 300 is shifted into the fourth gear position 4 based on the difference value (G1−G2) of the first output signal value G1 of the first detector 201 and the second output signal value G2 of the second detector 202.

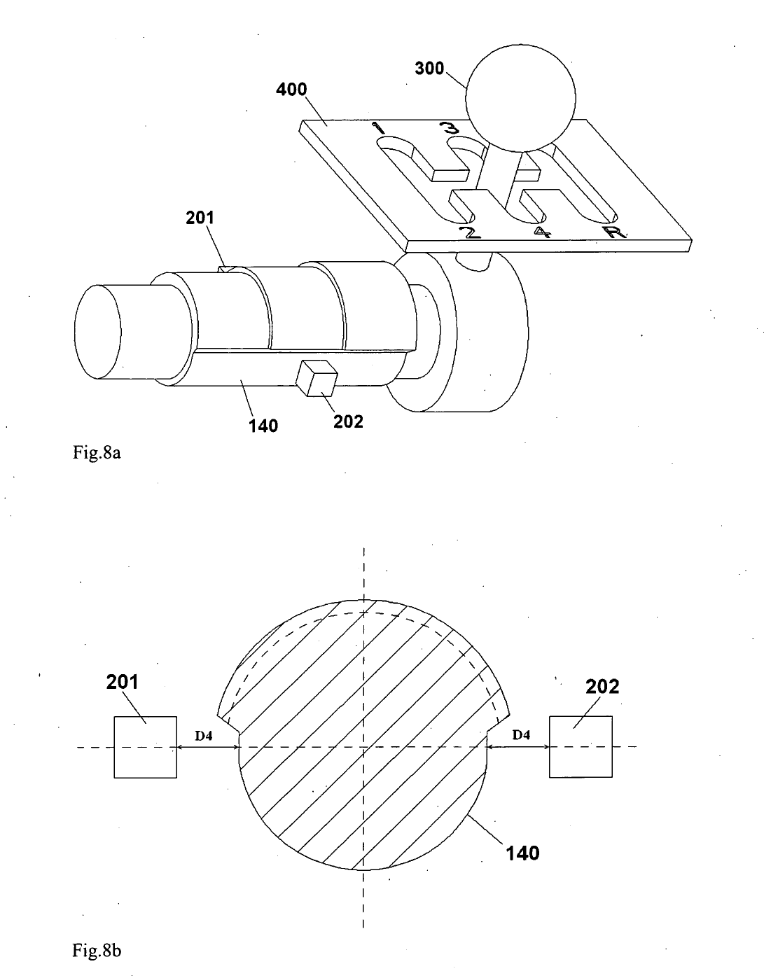

FIG. 8a is a schematic perspective view of a gear position detection device according to an embodiment of the present invention, showing the gear position detection device in a zero gear position between the third and fourth gear positions 3, 4; and FIG. 8b is a cross section view of FIG. 8a.

As shown in FIG. 8a and FIG. 8b, when the gear lever 300 is shifted into a zero gear position between the third and the fourth gear positions 3, 4, the first and the second detectors 201, 202 both face the fourth detection surface 140 and are away from the fourth detection surface 140 at the fourth distance D4. Thereby, the first detector 201 outputs a first output signal value G1 corresponding to the fourth distance D4, and the second detector 202 outputs a second output signal value G2 also corresponding to the fourth distance D4. Accordingly, at this time, it may determine that the gear lever 300 is shifted into the zero gear position based on the difference value (G1−G2) of the first output signal value G1 of the first detector 201 and the second output signal value G2 of the second detector 202.

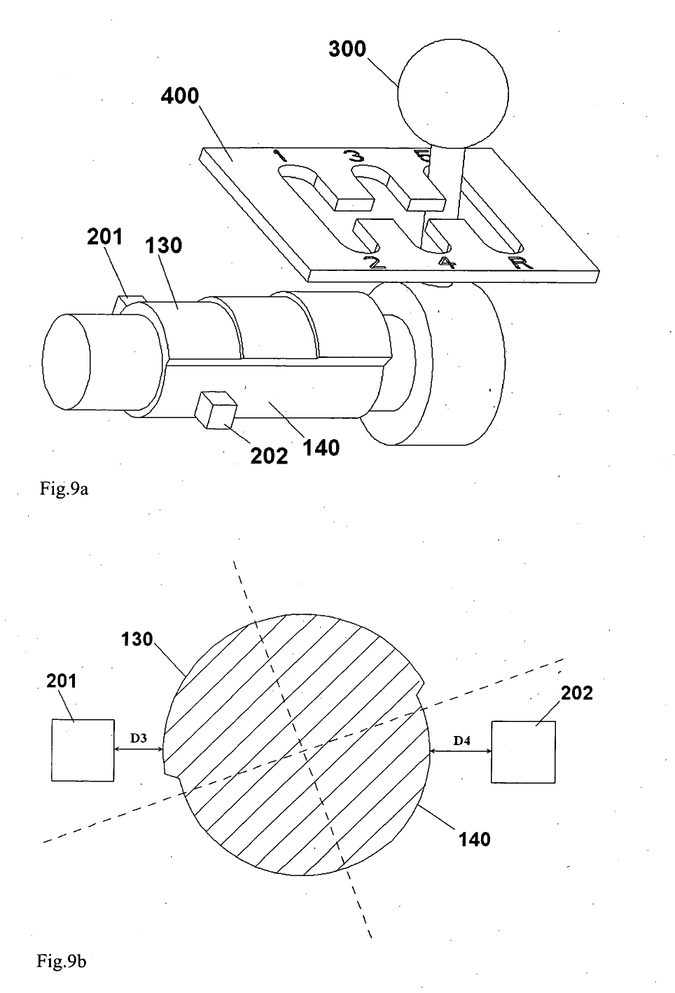

FIG. 9a is a schematic perspective view of a gear position detection device according to an embodiment of the present invention, showing the gear position detection device in a fifth gear position 5; and FIG. 9b is a cross section view of FIG. 9a.

As shown in FIG. 9a and FIG. 9b, when the gear lever 300 is shifted into a fifth gear position 5, the first detector 201 faces the third detection surface 130 and is away from the third detection surface 130 at a third distance D3, and the second detector 202 faces the fourth detection surface 140 and is away from the fourth detection surface 140 at a fourth distance D4. Thereby, the first detector 201 outputs a first output signal value G1 corresponding to the third distance D3, and the second detector 202 outputs a second output signal value G2 corresponding to the fourth distance D4. Accordingly, at this time, it may determine that the gear lever 300 is shifted into the fifth gear position 5 based on the difference value (G1−G2) of the first output signal value G1 of the first detector 201 and the second output signal value G2 of the second detector 202.

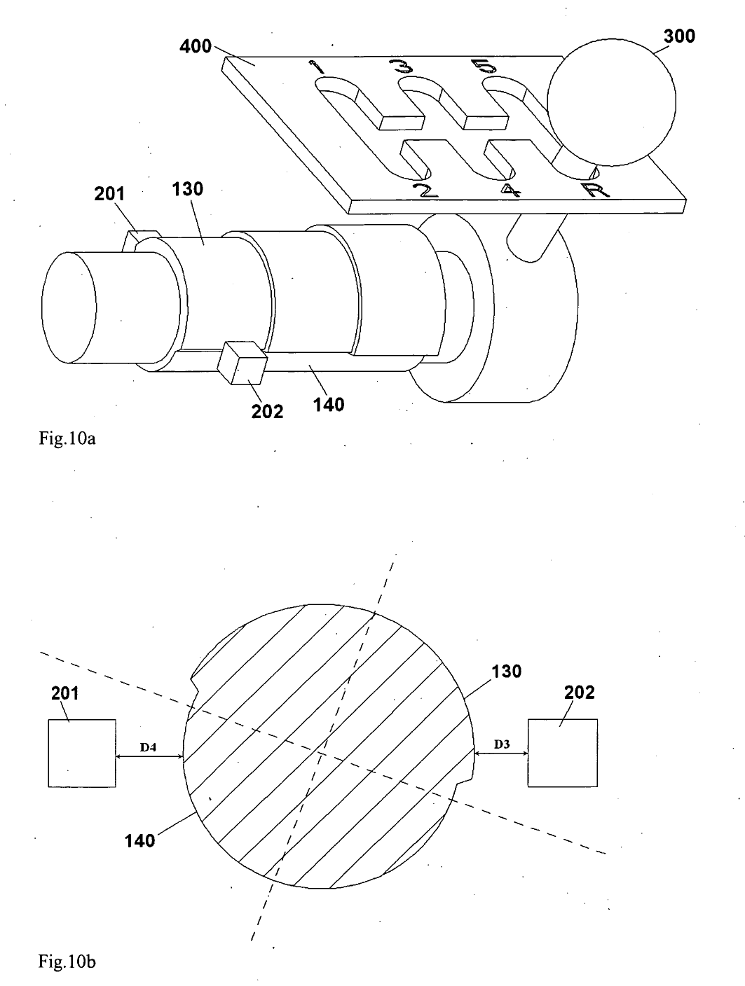

FIG. 10a is a schematic perspective view of a gear position detection device according to an embodiment of the present invention, showing the gear position detection device in a sixth gear position R; and FIG. 10b is a cross section view of FIG. 10a.

As shown in FIG. 10a and FIG. 10b, when the gear lever 300 is shifted into a sixth gear position R, the first detector 201 faces the fourth detection surface 140 and is away from the fourth detection surface 140 at the fourth distance D4; and the second detector 202 faces the third detection surface 130 and is away from the third detection surface 130 at the third distance D3. Thereby, the first detector 201 outputs a first output signal value G1 corresponding to the fourth distance D4, and the second detector 202 outputs a second output signal value G2 corresponding to the third distance D3. Accordingly, at this time, it may determine that the gear lever 300 is shifted into the sixth gear position R based on the difference value (G1−G2) of the first output signal value G1 of the first detector 201 and the second output signal value G2 of the second detector 202.

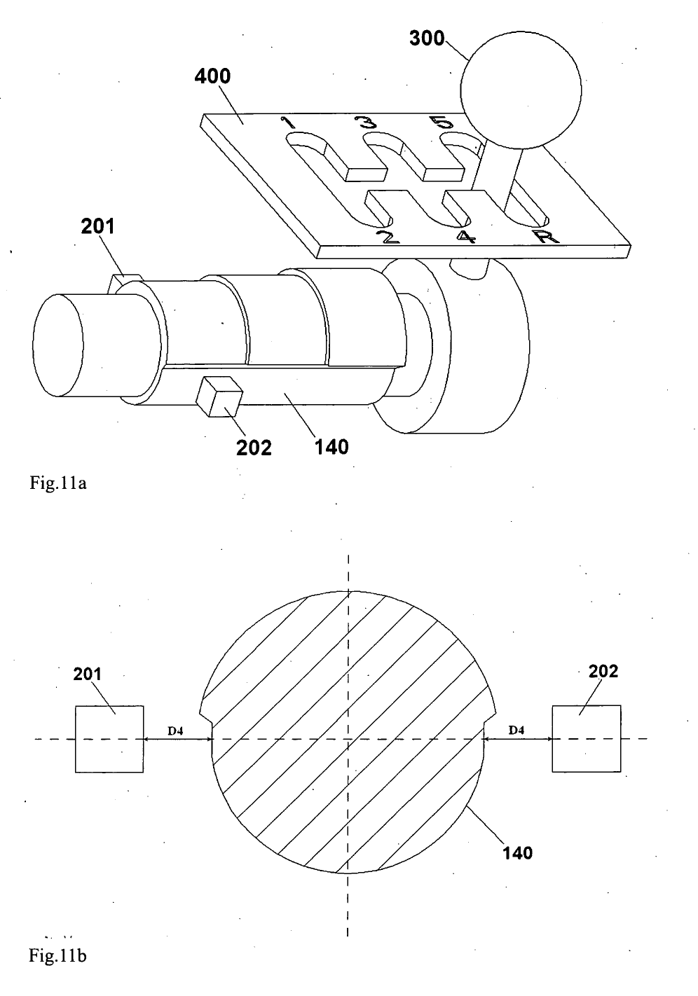

FIG. 11a is a schematic perspective view of a gear position detection device according to an embodiment of the present invention, showing the gear position detection device in a zero gear position between the fifth and sixth gear positions 5, 6; and FIG. 11b is a cross section view of FIG. 11a.

As shown in FIG. 11a and FIG. 11b, when the gear lever 300 is shifted into a zero gear position between the fifth and the sixth gear positions 5, R, the first and the second detectors 201, 202 both face the fourth detection surface 140 and are away from the fourth detection surface 140 at the fourth distance D4. Thereby, the first detector 201 outputs a first output signal value G1 corresponding to the fourth distance D4, and the second detector 202 outputs a second output signal value G2 also corresponding to the fourth distance D4. Accordingly, at this time, it may determine that the gear lever 300 is shifted into the zero gear position based on the difference value (G1−G2=0) of the first output signal value G1 of the first detector 201 and the second output signal value G2 of the second detector 202.

In order to distinguish and determine which of gear positions the gear lever 300 is shifted into, please be noted that a difference value of the first distance D1 and the fourth distance D4, a difference value of the second distance D2 and the fourth distance D4, and a difference value of the third distance D3 and the fourth distance D4 are neither equal to each other nor equal to zero, that is, the distances D1, D2, D3 and D4 satisfy a following relational expression:

D1−D4≠D2−D4≠D3−D4≠0 (2).

Please return to FIG. 2, in an exemplary embodiment of the present invention, the first distance D1=R0−R1, the second distance D2=R0−R2, the third distance D3=R0−R3 and the fourth distance D4=R0−R4. As shown in FIG. 2, therefore, the distances D1, D2, D3 and D4 further satisfy a following relational expression:

D1<D2<D3<D4 (3).

In another exemplary embodiment of the present invention, the shaft 100 is configured to be symmetrical about its axis so as to simplify manufacture thereof. But the present invention is not limited to this, the shaft 100 may be configured to be asymmetrical about its axis.

In another exemplary embodiment of the present invention, the first detector 201 and the second detector 202 both are linear displacement Hall sensors. But please be noted that the first detector 201 and the second detector 202 may be other types of displacement sensors, such as permanent magnetic linear non-contact displacement sensors or the like.

Although it is not shown, in another exemplary embodiment of the present invention, the determining means has a subtracter. Two input ends of the subtracter are connected to an output end of the first detector 201 and an output end of the second detector 202, respectively. An output end of the subtracter outputs the difference value of the first output signal value G1 from the first detector 201 and the second output signal value G2 from the second detector 202.

In another exemplary embodiment of the present invention, the first output signal value G1 and the second output signal value G2 each may be in a direct proportion to or in an inverse proportion to the distance from it to the shaft 100; and when the distance from the first detector 201 to the shaft 100 is equal to the distance from the second detector 202 to the shaft 100, the first output signal value G1 is equal to the second output signal value G2.

As described above, in order to distinguish and determine which of gear positions the gear lever 300 is shifted into, output signal of the subtracter at different gear positions should be different from each other.

For example, preferably, as an exemplary embodiment of the present invention, when the gear lever 300 is shifted into a first gear position 1, the first output signal value G1 of the first detector 201 is equal to 3, the second output signal value G2 of the second detector 202 is equal to zero, and the difference value of the first output signal value G1 and the second output signal value G2 is equal to 3;

when the gear lever 300 is shifted into a second gear position 2, the first output signal value G1 of the first detector 201 is equal to zero, the second output signal value G2 of the second detector 202 is equal to 3, and the difference value of the first output signal value G1 and the second output signal value G2 is equal to −3;

when the gear lever 300 is shifted into a third gear position 3, the first output signal value G1 of the first detector 201 is equal to 2, the second output signal value G2 of the second detector 202 is equal to zero, and the difference value of the first output signal value G1 and the second output signal value G2 is equal to 2;

when the gear lever 300 is shifted into a fourth gear position 4, the first output signal value G1 of the first detector 201 is equal to zero, the second output signal value G2 of the second detector 202 is equal to 2, and the difference value of the first output signal value G1 and the second output signal value G2 is equal to −2;

when the gear lever 300 is shifted into a fifth gear position 5, the first output signal value G1 of the first detector 201 is equal to 1, the second output signal value G2 of the second detector 202 is equal to zero, and the difference value of the first output signal value G1 and the second output signal value G2 is equal to 1;

when the gear lever 300 is shifted into a sixth gear position R, the first output signal value G1 of the first detector 201 is equal to zero, the second output signal value G2 of the second detector 202 is equal to 1, and the difference value of the first output signal value G1 and the second output signal value G2 is equal to −1;

when the gear lever 300 is shifted into a zero gear position between the first and the second gear positions 1, 2 or between the third and the fourth gear positions 3, 4 or between the fifth and the sixth gear positions 5, R, the first output signal value G1 of the first detector 201 is equal to zero, the second output signal value G2 of the second detector 202 is equal to zero, and the difference value of the first output signal value G1 and the second output signal value G2 is equal to zero.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. A gear position detection device, comprising:
a gear lever capable of being shifted into different gear positions;
a shaft connected to and driven by the gear lever;
a first detector and a second detector symmetrically arranged at both sides of the shaft,
the first detector for outputting a first output signal value G1 corresponding to a distance from the first detector to the shaft, and the second detector for outputting a second output signal value G2 corresponding to a distance from the second detector to the shaft; and
a means for determining the gear position of the gear lever based on a difference value of the first output signal value G1 and the second output signal value G2.

2. The gear position detection device according to claim 1, wherein the shaft having a first detection surface, a second detection surface, a third detection surface and a fourth detection surface;
when the gear lever is shifted into a first gear position, the first detector faces the first detection surface and is away from the first detection surface at a first distance D1, and the second detector faces the fourth detection surface and is away from the fourth detection surface at a fourth distance D4;
when the gear lever is shifted into a second gear position, the first detector faces the fourth detection surface and is away from the fourth detection surface at the fourth distance D4; and the second detector faces the first detection surface and is away from the first detection surface at the first distance D1;
when the gear lever is shifted into a zero gear position between the first and the second gear positions, the first and the second detectors both face the fourth detection surface and are away from the fourth detection surface at the fourth distance D4;
when the gear lever is shifted into a third gear position, the first detector faces the second detection surface and is away from the second detection surface at a second distance D2, and the second detector faces the fourth detection surface and is away from the fourth detection surface at a fourth distance D4;
when the gear lever is shifted into a fourth gear position, the first detector faces the fourth detection surface and is away from the fourth detection surface at the fourth distance D4; and the second detector faces the second detection surface and is away from the second detection surface at the second distance D2;
when the gear lever is shifted into a zero gear position between the third and the fourth gear positions, the first and the second detectors both face the fourth detection surface and are away from the fourth detection surface at the fourth distance D4;
when the gear lever is shifted into a fifth gear position, the first detector faces the third detection surface and is away from the third detection surface at a third distance D3, and the second detector faces the fourth detection surface and is away from the fourth detection surface at a fourth distance D4;
when the gear lever is shifted into a sixth gear position (R), the first detector faces the fourth detection surface and is away from the fourth detection surface at the fourth distance D4; and the second detector faces the third detection surface and is away from the third detection surface at the third distance D3;
when the gear lever is shifted into a zero gear position between the fifth and the sixth gear positions, the first and the second detectors both face the fourth detection surface and are away from the fourth detection surface at the fourth distance D4; and
wherein a difference value of the first distance D1 and the fourth distance D4, a difference value of the second distance D2 and the fourth distance D4, and a difference value of the third distance D3 and the fourth distance D4 are neither equal to each other nor equal to zero, that is, the distances D1, D2, D3 and D4 satisfy a following relational expression:
D1−D4≠D2−D4≠D3−D4≠0.

3. The gear position detection device according to claim 2, wherein the distances D1, D2, D3 and D4 further satisfy the following relational expression:
D1<D2<D3<D4.

4. The gear position detection device according to claim 2, wherein the first, second, third and the fourth detection surfaces are arc surfaces with radiuses R1, R2, R3 and R4, respectively.

5. The gear position detection device according to claim 4, wherein the radiuses R1, R2, R3 and R4 satisfy a following relational expression:
R1>R2>R3>R4.

6. The gear position detection device according to claim 1, wherein the shaft is symmetrical about its axis.

7. The gear position detection device according to claim 1, wherein the first detector and the second detector both are linear displacement Hall sensors.

8. The gear position detection device according to claim 1, wherein the determining means has a subtracter;
input ends of the subtracter are connected to output ends of the first and second detectors; and
an output end of the subtracter outputs the difference value of the first output signal value G1 from the first detector and the second output signal value G2 from the second detector.

9. The gear position detection device according to claim 1, wherein the first output signal value G1 and the second output signal value G2 each is in an inverse proportion to the distance from it to the shaft; and
when the distance from the first detector to the shaft is equal to the distance from the second detector to the shaft, the first output signal value G1 is equal to the second output signal value G2.

10. The gear position detection device according to claim 9, wherein
when the gear lever is shifted into a first gear position, the first output signal value G1 of the first detector is equal to 3, the second output signal value G2 of the second detector is equal to zero, and the difference value of the first output signal value G1 and the second output signal value G2 is equal to 3;
when the gear lever is shifted into a second gear position, the first output signal value G1 of the first detector is equal to zero, the second output signal value G2 of the second detector is equal to 3, and the difference value of the first output signal value G1 and the second output signal value G2 is equal to −3;
when the gear lever is shifted into a third gear position, the first output signal value G1 of the first detector is equal to 2, the second output signal value G2 of the second detector is equal to zero, and the difference value of the first output signal value G1 and the second output signal value G2 is equal to 2;
when the gear lever is shifted into a fourth gear position, the first output signal value G1 of the first detector is equal to zero, the second output signal value G2 of the second detector is equal to 2, and the difference value of the first output signal value G1 and the second output signal value G2 is equal to −2;
when the gear lever is shifted into a fifth gear position, the first output signal value G1 of the first detector is equal to 1, the second output signal value G2 of the second detector is equal to zero, and the difference value of the first output signal value G1 and the second output signal value G2 is equal to 1;
when the gear lever is shifted into a sixth gear position, the first output signal value G1 of the first detector is equal to zero, the second output signal value G2 of the second detector is equal to 1, and the difference value of the first output signal value G1 and the second output signal value G2 is equal to −1;
when the gear lever is shifted into a zero gear position between the first and the second gear positions or between the third and the fourth gear positions or between the fifth and the sixth gear positions, the first output signal value G1 of the first detector is equal to zero, the second output signal value G2 of the second detector is equal to zero, and the difference value of the first output signal value G1 and the second output signal value G2 is equal to zero.
